(19) United States
(12) Patent Application Publication
(10) Pub. No.: US 2008/0169209 A1
(43) Pub. Date: Jul. 17, 2008

(54) Devices and methods for skin surface preparation

(76) Inventor: Jamie Glen House, Colorado Springs, CO (US)

Correspondence Address: MOAZZAM & ASSOCIATES, LLC, 7601 LEWINSVILLE ROAD, SUITE 304, MCLEAN, VA, 22102, US

(21) Appl. No.: 11/652,525

(22) Filed: Jan. 12, 2007

(51) Int. Cl. B65D 69/00; C11D 3/48

(52) U.S. Cl. 206/229; 206/223; 510/130

(57) ABSTRACT

Devices, methods and kits are disclosed for both providing antiseptic and adhesive to a skin surface in one step. Various kits are presented to contain the combination adhesive-antiseptic solution. The applications of the kit include the prepping of a penis prior to the fitting of an external condom catheter.

### BACKGROUND OF THE INVENTION

1. Field of the Invention

The present invention relates generally to devices and methods for skin surface preparation. More particularly, the present invention relates to skin surface preparation kits.

2. Background of the Invention

In home and hospital settings, it is common practice to employ catheterization devices to drain urine from patients. Such catheterization devices include indwelling catheters, intermittent catheters, and external catheters, which are also known as condom catheters.

In patients with normal control over bladder functions, an external catheter is sometimes used instead of an indwelling or intermittent catheter since the risk of infection or other disease may be minimized with an external catheter. An external catheter is not inserted into the patient's urethra, and it therefore may have some advantages over other current catheterization devices that require temporary or prolonged urethral insertion in order to drain the urine from the bladder.

An external catheter is placed over a patient's penis like a condom used for sexual intercourse and has at its end a reservoir connected to a tube which is connected to a collection bag. Earlier external catheters were not self-adhesive and a band around the catheter was used to hold the catheters in place on the penis. Later advancements were made in the adhesive techniques which resulted in lining the inside of the catheter with a glue-like substance. This caused the condom-like catheter to stick to the flaccid penis and keep it in place throughout the day. Some also use a skin-prepping pad that is wiped on the penis before the external catheter is applied which quickly turns into a sticky gel-like substance which further causes the catheter to stick to the penis. This pad is so sticky when first applied that it is difficult to remove without damaging the skin.

An external catheter is usually used on patients who have an ability to control their bladder functions but may have limited hand dexterity or ability to get to a toilet, or may be unable to direct their urine flow into a urinal. Also, an external catheter can be used on individuals having abnormal bladder function but who may still experience spontaneous bladder contraction after their bladder is full. This often occurs in patients with stroke, multiple sclerosis, spinal cord injury, traumatic brain injury, etc. An external catheter is not normally used for patients with bladders that are unable to contract, such as patients with spina bifida. External catheters have been mostly comprised of a latex material until recently when silicon catheters have become popular.

There are studies that have shown that the rate of urinary tract and bladder infection is lower for individuals who change their external condom catheter daily as compared to every other day. Therefore, most doctors recommend that an external catheter be changed every day to prevent infections. However, infections do still occur at a significant rate in those individuals who depend on external catheters due to the prolonged presence of residual urine within the tip of the external catheter.

Thus, there is a need in the healthcare industry for a skin preparation technique that may be used with an external catheter, and that functions to decrease the rate of incidence of infection, particularly when in use with external catheters.

### SUMMARY OF THE INVENTION

The current techniques and devices for catheterization are inefficient and expose the patient to infection. In current external catheterization devices, residual urine collects in the reservoir of the catheter. Such residual urine can be associated with an increase in bacterial and/or yeast infection and may arise from the proliferation of skin bacteria and/or yeast within this urine medium. This collection of bacteria and/or yeast within the external catheter likely results in urinary tract and bladder infections by migration of these organisms retrograde through the urethra and into the bladder. These infections may still arise even if the external catheter is changed daily. In order to prevent this bacterial and/or yeast proliferation, the present invention proposes devices and methods for skin preparation using antiseptic coatings in conjunction with adhesive compound coatings prior to use with an external catheter making contact with the shaft of a penis.

In one exemplary embodiment, the present invention is a kit for skin preparation. The kit includes a solution including an adhesive agent and an antiseptic agent; and a package for containing the solution.

In another exemplary embodiment, the present invention is a device for preparation of skin prior to application of an external condom catheter. The device includes a solution including an adhesive agent and an antiseptic agent to cleanse a surface of a penis; and a package for containing the solution sterile until use.

In yet another exemplary embodiment, the present invention is a method for skin preparation. The method includes contacting the skin with a solution including an adhesive agent and an antiseptic agent.

In various exemplary embodiments, an antiseptic agent is chosen from a group of agents consisting of: nitrofurazone, chlorhexadine, silver sulfadiazine, minocycline, rifampin, nystatin, fluconazole, miconazole, troconazole, ibutoconazole, or any combination thereof.

### BRIEF DESCRIPTION OF THE DRAWINGS

FIG. 1A shows a perspective view of a skin preparation kit according to an exemplary embodiment of the present invention.

FIG. 1B shows a perspective view of a skin preparation kit with strip portion opened according to an exemplary embodiment of the present invention.

FIG. 1C shows a perspective view of a skin preparation with preparation pad removed according to an exemplary embodiment of the present invention.

FIG. 2A shows a side view of a skin preparation kit according to another exemplary embodiment of the present invention.

FIG. 2B shows a side view of a skin preparation kit with its applicator brush removed from a container according to an exemplary embodiment of the present invention.

FIG. 3 shows a side view of a skin preparation kit according to another exemplary embodiment of the present invention.

### DETAILED DESCRIPTION OF THE INVENTION

The present invention provides for skin preparation devices and methods which prevent bacterial and/or yeast proliferation within the catheterization devices thereby preventing infection. In particular embodiments and examples presented herein, use of the present invention is made specifically with urinary catheterization but it must be noted that such antiseptic and adhesive compound coatings according to the present invention are not limited to urinary catheters alone but may be applicable to any catheterization device that could benefit from the use of such coatings.

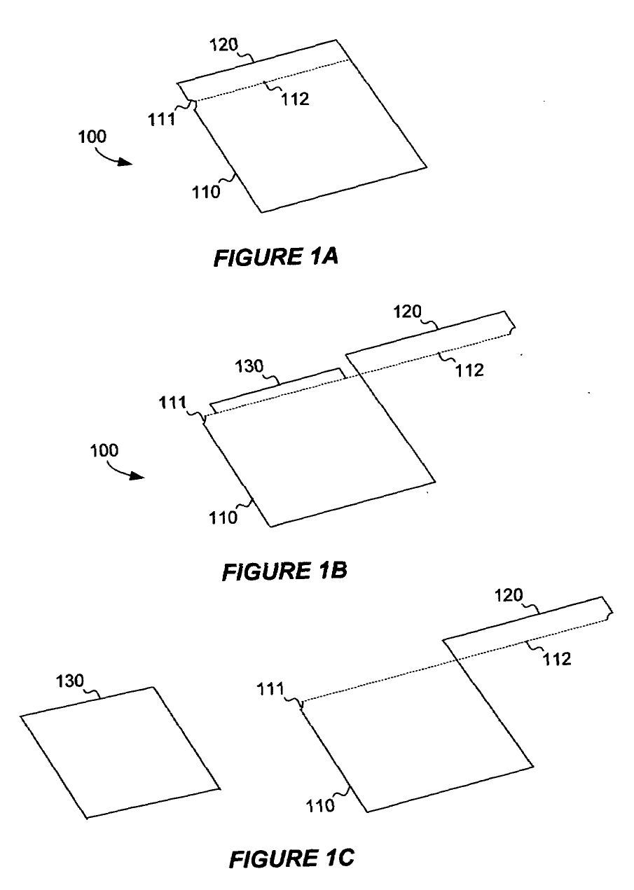

As shown in the exemplary embodiment in FIGS. 1A-1C, a skin preparation kit 100 includes a kit that contains a package 110 with a detachable strip 120 that can be stripped away at a perforation 112. A guide notch 111 assists a user in easily removing the detachable strip 120 from the package 110. As shown in FIG. 1B, once the detachable strip 120 is partially or fully removed, a skin preparation (“prep”) pad 130 is exposed. Such pad 130 has been maintained in a sterile environment within package 110 until the removal of the strip 120. Once the strip 120 is partially or fully removed, the skin preparation pad 130 can be removed and used. This skin preparation pad 130 contains both adhesive and antiseptic agents. At least one agent of each type should be included. Alternatively, an agent that has both adhesive and antiseptic properties may be included.

Once removed, the skin prep pad 130 is used to rub against the skin of the body portion (such as penis) to allow the adhesive/antiseptic compounds to be transferred to the body portion. Thus, through the use of this single skin prep pad 130, the body portion (such as penis) is both cleansed/disinfected/sterilized (depending on the compound used) and made tacky by the use of the adhesive. After such application of the skin prep pad 130, the body portion (such as penis) is then ready to receive a medical device (such as an external condom catheter).

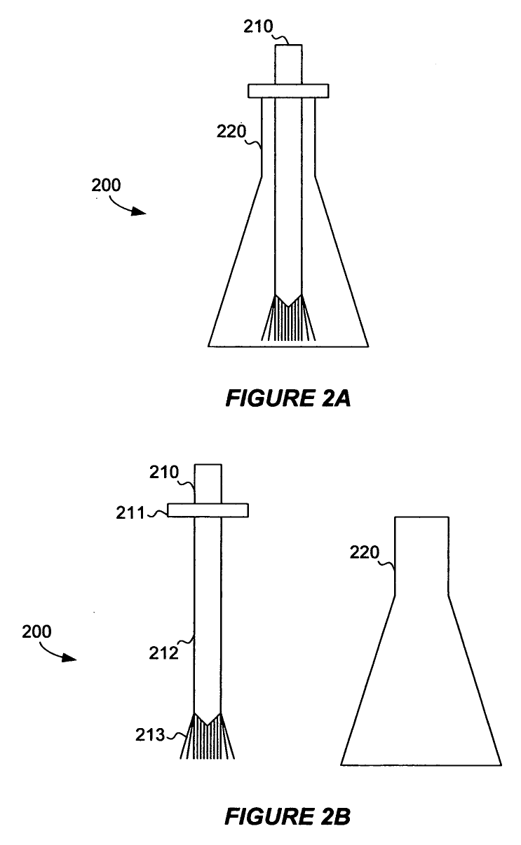

Another exemplary embodiment of the present invention is shown in FIGS. 2A-2B. In this embodiment, the combination adhesive-antiseptic solution is contained within a kit 200 that includes a package 220 that contains the solution. An applicator 210 may be fitted into package 220 using a screw motion, friction fit or equivalent. The applicator 210 has a stopper 211 that limits the length of a shaft 212 that may be inserted into the package 220. The shaft 212 ends with a brush 213 that assists in the application of the solution on a body portion. The brush 213 may be substituted with equivalents such as cotton ball, absorbent material or the like. The combination adhesive-antiseptic solution is maintained within the package 220 until time of use. At such point, the applicator 210 is removed from the package 220 and positioned such that the brush 213 is used to apply the combination adhesive-antiseptic solution onto the portion of the body which is to be cleansed/disinfected/sterilized. After application of the solution onto the body portion, the body portion (such as a penis) is then prepped for the attachment of a medical device (such as an external condom catheter).

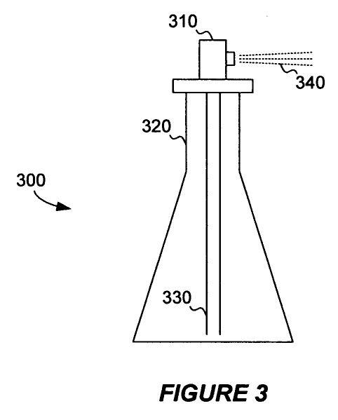

In yet another exemplary embodiment of the present invention, a spray kit 300 is presented in FIG. 3. In this embodiment, the combination adhesive-antiseptic solution is maintained in a package 320 which has an applicator 310 that can be irreversibly affixed to the package 320 (in contrast to the applicator 210 which is reversibly affixed to package 220, shown in FIG. 2). Applicator 320 has a small tube 330 which extends to a bottom portion of the package 330 to allow for the suctioning of solution from such bottom portion through a spray head at the top of applicator 310, resulting in a spray or stream 340 onto a target body portion. This exemplary embodiment preserves the combination solution such that there is no potential or actual exposure to an external environment other than through the spray or stream 340. Thus, the package 320 is maintained sealed at all times other than during use, in which there is a fluid flow out of the package 320. In this embodiment, no part of the device or kit, other than the combination solution itself, makes contact with the body portion. This embodiment may be most useful where such body portion is injured, damaged or otherwise sensitive to contact.

The exemplary embodiments presented as kits in FIGS. 1-3 are not intended to be exhaustive of the techniques that may be used to apply a combination solution of adhesive and antiseptic onto a targeted body portion. Many other kits may also be possible and apparent to one having ordinary skill in the art after consideration of the present disclosure. Such other kits are also within the scope of the present invention.

The antiseptic agent may be composed of any anti-bacterial compound that effectively prevents the growth of bacteria (e.g., bacteriostatic) or yeast (e.g., anti-yeast) and/or kills bacteria (e.g., bacteriocidal) or yeast once they are formed. The antiseptic agent should preferably be safe, non-irritating, and hypoallergenic such that it does not cause any adverse reactions to the skin of the patient. An exemplary anti-bacterial agent that may be used in the antiseptic agent for the present invention may be nitrofurazone, chlorhexadine, silver sulfadiazine, minocycline, rifampin, or any combination thereof. An exemplary anti-yeast agent that may be used in the antiseptic agent for the present invention may include, but not be limited to nystatin, fluconazole, miconazole, troconazole, ibutoconazole, or any combination thereof. Some of these compounds have been effectively and safely used in Foley catheters (e.g., indwelling catheters) to prevent bacterial or yeast infection. Thus, a spray or application of these compounds for the present invention may provide a safe and effective prevention of bacterial and/or yeast growth and subsequent infection.

Other solutions or compounds may also be used, including but not limited to, isopropyl alcohol, butyl ester of PVM/MA copolymer, acetyl tributyl citrate, or the like. One having ordinary skill in the art would be cognizant of the types of compounds to use in the present invention after consideration of the present disclosure.

The adhesive material used for this invention may be composed of any compound that when applied to the inner surface of the catheter, may bind with the epithelial cells of a body portion (such as the penis) such that the medical device being positioned (such as a catheter) remains stable and secure. The adhesive compound may also be non-irritating such that it may be removed from the body portion without causing any irritation. The adhesive compound may be strong enough to resist, for example, any sliding movement of the catheter on the penis, but should preferably not be so strong so as to cause pain during removal of the catheter. An exemplary adhesive compound may be an acrylic resin as used in conventional catheters, but any other adhesive compound that would satisfy the above mentioned limitations would be suitable for use in the present invention as well.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A kit for skin preparation, the kit comprising:
a solution including an adhesive agent and an antiseptic agent; and
a package for containing the solution.

2. The kit of claim 1, wherein the antiseptic agent contains an anti-bacterial and/or anti-yeast compound.

3. The kit of claim 2, wherein the anti-bacterial compound is composed of nitrofurazone, chlorhexadine, silver sulfadiazine, minocycline, rifampin, or any combination thereof.

4. The kit of claim 2, wherein the anti-yeast compound is composed of nystatin, fluconazole, miconazole, troconazole, ibutoconazole, or any combination thereof.

5. The kit of claim 1, wherein the adhesive material is an acrylic resin.

6. The kit of claim 1, wherein the package has a detachable strip that is removed to expose a pad containing the solution.

7. The kit of claim 1, wherein the package has an applicator that is reversibly attachable to the package.

8. The kit of claim 7, wherein the applicator contains a brush.

9. The kit of claim 1, wherein the package has an applicator that is irreversibly attachable to the package.

10. The kit of claim 9, wherein the applicator has a spray nozzle.

11. A device for preparation of skin prior to application of an external condom catheter, the device comprising:
a solution including an adhesive agent and an antiseptic agent to cleanse a surface of a penis; and
a package for containing the solution sterile until use.

12. The device of claim 11, wherein the antiseptic agent is composed of an anti-bacterial and/or anti-yeast compound.

13. The device of claim 12, wherein the anti-bacterial compound is composed of nitrofurazone, chlorhexadine, silver sulfadiazine, minocycline, rifampin, or any combination thereof.

14. The device of claim 12, wherein the anti-yeast compound is composed of nystatin, fluconazole, miconazole, troconazole, ibutoconazole, or any combination thereof

15. The device of claim 11, wherein the adhesive material is an acrylic resin.

16. The device of claim 11, wherein the package has a detachable strip that is removed to expose a pad containing the solution.

17. The device of claim 11, wherein the package has an applicator that is reversibly attachable to the package.

18. The device of claim 17, wherein the applicator contains a brush.

19. The device of claim 11, wherein the package includes an applicator with a spray nozzle.

20. A method for skin preparation, the method comprising:
contacting the skin with a solution including an adhesive agent and an antiseptic agent.
